(19) United States
(12) Patent Application Publication
(10) Pub. No.: US 2017/0158894 A1
(43) Pub. Date: Jun. 8, 2017

(54) INK JET PRINTER INK COMPRISING EFFECT PIGMENTS HAVING HIGH GLOSS

(71) Applicant: Eckart GmbH, Hartenstein (DE)

(72) Inventors: Michael Becker, Lauf (DE); Stefan Engel, Rückersdorf (DE)

(21) Appl. No.: 15/436,237

(22) Filed: Feb. 17, 2017

Related U.S. Application Data
(63) Continuation of application No. 13/389,037, filed on Feb. 7, 2012, now abandoned.

(30) Foreign Application Priority Data
Aug. 14, 2009 (DE) 10 2009 037 323.3

(51) Int. Cl. C09D 11/322; C09D 11/14; B41J 2/01; C09D 11/36

(52) U.S. Cl. CPC C09D 11/322; C09D 11/36; C09D 11/14; B41J 2/01

(57) ABSTRACT

An ink jet printer ink comprising effect pigments and organic solvents or solvent mixtures, wherein the effect pigments comprise a) aluminum effect pigments having a mean thickness in a range of 10 to 100 μm and a d₉₈ value of the cumulative frequency distribution of the volume-averaged size distribution function of less than 15 μm and/or b) pearlescent pigments having a d₉₀ value of the cumulative frequency distribution of the volume-averaged size distribution in a range of 3.5 to 15 μm. The viscosity of the ink jet printer ink is 1 to mPa*s and the weight ratio of effect pigment to binder is 2 to 15. The invention further relates to the use of the ink jet printer ink.

### CROSS-REFERENCE TO RELATED APPLICATIONS

The present patent application is a continuation of prior U.S. patent application Ser. No. 13/389,037, filed Feb. 7, 2012, by Michael Becker and Stefan Engel, entitled “INK JET PRINTER INK COMPRISING EFFECT PIGMENTS HAVING HIGH GLOSS,” which is a 35 U.S.C. §371 National Phase conversion of International Application No. PCT/EP2010/004983, filed Aug. 13, 2010, which claims the benefit of German Patent Application No. 10 2009 037 323.3, filed Aug. 14, 2009. The PCT International Application was published in the German language. The entire contents of each of these patent applications are incorporated herein by reference.

### BACKGROUND OF THE INVENTION

Colored ink jet printer inks have been used for many years. Ink jet printer inks pigmented with effect pigments, however, are virtually still commercially unavailable. Effect pigments have a platelet-shaped structure and typical dimensions in the range 5-50 μm and so are normally too large for customary ink jet printers. Ink jet printers comprise a narrow system of channels, tubes and nozzle. Further issues with effect pigments are changed viscosities of ink jet printer inks and settling problems affecting effect pigments.

A number of applications for a patent have recently been filed in relation to this topic. They describe platelet-shaped aluminum effect pigments sufficiently small not to cause print head clogging. Surprisingly, these small aluminum effect pigments have a good optical effect nonetheless.

WO 2009/083176 A1 discloses aluminum effect pigments useful in ink jet printer ink by virtue of their very small size. The aluminum effect pigments are comminuted in the presence of certain additives by grinding.

WO 2009/010288 A2 discloses aluminum effect pigments, and ink jet printer ink pigmented therewith, which have very small average thicknesses and small sizes and are obtainable by grinding.

WO 2004/035684 A2 discloses aqueous ink jet printer inks comprising effect pigments.

US 2006/0034787 A1 discloses PVD-produced effect pigments having a middle layer of aluminum flanked on both sides by layers of SiO_{z}, where 0.70≦z≦2.0. These pigments can inter alia also be used in ink jet printer inks.

WO 2007/054379 A1 discloses interference pigments based on thin flakes of glass. These can be used in ink jet printer inks as well as many other applications.

EP 1 862 511 A1 likewise discloses metal effect pigments and ink jet printer inks pigmented therewith.

US 2008/0250970 A1 discloses inter alia ink jet printer inks which may be pigmented with low concentrations of metal effect pigments. When the ink jet printer inks are printed onto photographic paper, the printed colors exhibit very high gloss. Photographic paper is a highly absorbent medium where, for example, binders diffuse into the substrate and where for that reason it is virtually always possible to obtain high-gloss applications. Photographic paper is comparatively uninteresting commercially as substrate for printing.

Ink jet printer inks pigmented with metal effect pigments are likewise disclosed in US 2008/0182083 A1.

The prior art discloses ink jet printer inks pigmented with effect pigments. However, the known pigmented ink jet printer inks frequently do not develop an optimal effect on application, especially when the pigmented ink jet printer inks are applied to non-absorbent media. Commonly, a high effect pigment/binder ratio is required in the ink jet printer ink. However, the rub and wipe resistance of the print suffers as a result.

### SUMMARY OF THE INVENTION

The present invention has for its object to provide, in an inexpensive manner, an effect-pigmented ink jet printer ink that is free of these disadvantages. More particularly, the ink jet printer ink to be provided shall enable good effect development and especially a high gloss even when printed on non-absorbent mediums. At the same time, ideally, the print should have high to sufficient rub and wipe resistance.

The object of the present invention is achieved by providing an ink jet printer ink comprising effect pigments and organic solvents or a solvent mixture, wherein the effect pigments comprise

a) aluminum effect pigments having an average thickness from a range of 10 to 100 nm and having a d₉₈ value of less than 15 μm for the cumulative frequency distribution of the volume-averaged size distribution function, and/or

b) pearl luster pigments having a d₉₀ value from a range of 3.5 to 15 μm for the cumulative frequency distribution of the volume-averaged size distribution function, and wherein the ink jet printer ink has a viscosity from a range of 1 to 50 mPa·s and an effect pigment to binder weight ratio in the range from 2 to 15.

### DESCRIPTION OF PREFERRED EMBODIMENTS

Aluminum effect pigments are used as effect pigments in one preferable embodiment. The aluminum effect pigments used can be aluminum effect pigments obtained by PVD processes and also known as PVD aluminum effect pigments, or aluminum effect pigments obtained by grinding. Preference is given to using the aluminum effect pigments disclosed in WO 2009/083176 A1, as pigment preparation. The content of this document is hereby incorporated herein by reference.

Aluminum effect pigments are platelet shaped and assume a largely parallel orientation to the medium to which they have been applied. They act as small mirrors, reflecting directly incident light. When these pigments are comminuted down to a median size distinctly below 1 μm (d₅₀), they are too small to still be able to develop the typical metallic luster, lightness and light-dark flop. Surprisingly, however, these effects can be observed at average sizes above 1 μm. In one preferable version of the invention, the median size (d₅₀) is accordingly at least 1 μm.

The d₅₀, d₉₈ and d₁₀₀ values are based on the volume-averaged particle size distribution when represented as cumulative frequency distribution. This is measured using laser granulometry on the basis of Fraunhofer diffraction theory. Typically, a Cilas 1064 type instrument (from Cilas, Orleans, France) is used for this purpose.

When the d₉₈ value is above 15 μm, the aluminum effect pigments are no longer able to pass through the printing equipment, which comprises a system of tubes, channels, filters and the print head. Cloggages would occur and the print head would be unusable.

In one preferable embodiment of the present invention, the aluminum effect pigments have a d₉₈ value from a range of 2 μm to 12 μm, more preferably of 2.5 μm to 8 μm and even more preferably of 3 μm to below 6 μm.

In these preferable embodiments, the d₅₀ value of the particle size distribution is in a range of 1 to below 6 μm, more preferably of 1.5 to 5 μm, even more preferably 1.2 to 5 μm and yet even more preferably of 1.5 to 5 μm and most preferably of 2 to 5 μm.

The size distribution curve of the aluminum effect pigments is very narrow. Preferably, 100% of the aluminum effect pigments in the ink jet printer ink of the present invention have a d₁₀₀ value of below 15 μm, more preferably of below 12 μm, even more preferably of below 10 μm and most preferably of below 6 μm.

In further preferable embodiments, 100% of the aluminum effect pigment particles are in a size range of 0.3 to 8 μm and more preferably of 0.5 to 7 μm.

Preference is given to using aluminum effect pigments having a d₁₀₀ of below 12 μm and more preferably of below 10 μm, since for example the diameter of the nozzles or other print head parts through which the printing ink has to pass are usually in a range of 20 to 50 μm.

In principle, the upper limit of the aluminum effect pigments is determined by the diameters of the entire print head configuration such as tubes, channels, filters, and nozzles. The print head system has to be able to act as a pump for the ink jet printer ink. When the aforementioned elements of the print head have larger diameters, larger-dimensioned aluminum effect pigments can also be used.

The ratio of the d₅₀ value of the aluminum effect pigments to the diameter of the print head nozzle is preferably in a range of 0.02 to 0.5 and more preferably of 0.03 to 0.2 and even more preferably of 0.04 to 0.12.

Platelet-shaped aluminum effect pigments with dimensions within the abovementioned ratio range are easily able to pass through the print head nozzles without cloggage.

To get to such small aluminum effect pigments, these are preferably comminuted by a grinding step and converted into a pigment preparation. This pigment preparation, as described in WO 2009/083176 A1, preferably comprises aluminum effect pigments, at least one solvent and at least one additive, wherein the aluminum effect pigments have a d₉₈ value of less than 15 μm for the volume-averaged cumulative distribution curve.

The at least one additive is as described in WO 2009/083176 a phosphorus-containing additive and the solvent has a viscosity of at least 1.8 mPa·s at 25° C.

In a further preferable embodiment, the phosphorus-containing additive comprises at least one phosphinic acid, phosphinic ester, phosphonic acid, phosphonic ester, phosphoric acid and/or phosphoric ester.

The phosphoric acid or phosphoric esters have the following general formula (I):

(O)P(OR¹)(OR²)(OR³) (I).

The phosphonic acid or phosphonic esters have the following general formula (II):

(O)PR⁴(OR¹)(OR²) (II).

The phosphinic acid or phosphinic esters have the following general formula (III):

(O)PR⁴R⁵(OR¹) (III)

where

R¹, R² and R³ are each independently H or an organic moiety having 1 to 30 carbon atoms, which optionally contains hetero atoms such as O, S, and/or N, and R⁴ and R⁵ are each independently an organic moiety having 1 to 30 carbon atoms, which optionally contains hetero atoms such as O, S, and/or N.

All organic moieties R¹, R², R³, R⁴ or R⁵ may each be independently branched or straight-chain alkyl, alkylaryl, aryl or arylalkyl.

Preferably, the organic moieties are branched or straight-chain alkyl having 1 to 24 carbon atoms, preferably 6 to 18 carbon atoms, which optionally contain hetero atoms such as O, S, and/or N.

Particular preference is given to alkylphosphonic acids and alkylphosphonic esters, which more preferably comprise an alkyl moiety having 6 to 18 carbon atoms and even more preferably having 6 to 18 carbon atoms.

Very particular preference is given to octanephosphonic acid or dodecylphosphonic acid.

In one particularly preferable embodiment, the aluminum effect pigments are obtained in a known manner via PVD processes.

In a further preferable embodiment, the aluminum effect pigments are obtained by grinding. Preference is given to using the aluminum effect pigments disclosed in WO 2009/010288 A2. The content of this document is hereby incorporated herein by reference.

To obtain the aluminum effect pigments used according to the present invention by using a ball mill, aluminum is melted in a first step and subsequently atomized using the techniques the skilled person knows. The ball-shaped particles obtained by atomization are subsequently bead or ball milled to the particle size desired for the aluminum effect pigments. The operation of ball or bead milling particles of metal is known as “Hall process”.

To obtain very thin pigments, preference is given to using spherical balls consisting of a material having a weight of 2 to 13 mg per ball. Glass balls are preferably used for this purpose. It is also preferable to use a fine platelet-shaped aluminum pigment as starting material for the manufacture of aluminum effect pigments for use in the ink jet printer ink of the present invention.

The average particle size (d₅₀) of the aluminum grit, d_{50,grit}, which is used for producing these thin aluminum effect pigments is <20 μm, preferably <15 μm, more preferably <10 μm and most preferably <8 μm. In a further embodiment of the invention, the average particle size distribution is characterized as follows: d_{10,grit}<3 μm, d_{50,grit}<5 μm, d_{90,grit}<8 μm.

To obtain a very thin aluminum effect pigment having a very small thickness distribution, for example an aluminum effect pigment having an average thickness h₅₀ of 15 to 80 nm and a thickness span (thickness distribution) Δh of 30 to less than 70% as per formula (I), it is preferable to use a very fine aluminum grain, i.e., a very fine aluminum grit, having a narrow size distribution as starting material. The thickness distribution is specified in the form of a cumulative distribution (number average). The relative width of the thickness distribution Δh (“thickness span”) is determined by calculation using formula (I)

Δh=100(h₉₀−h₁₀)/h₅₀ (I).

The h₉₀ value indicates the maximum pigment thickness of 90% of the particles. Correspondingly, the h₁₀ value indicates the maximum pigment thickness of 10% of the particles.

Preference is given to using an aluminum grain (aluminum grit) having a particle size of d_{10,grit}<3.0 μm, d_{50,grit}<5.0 μm and d_{90,grit}<8.0 μm. It is more preferable to use an aluminum grain (aluminum grit) having a particle size of d_{10,grit}<0.6 μm, d_{50,grit}<2.0 μm and d_{90,grit}<4.0 μm.

Particle thickness is normally ascertained by determining the spread value (in line with DIN 55923) and using it to calculate the particle thickness, and/or by counting and averaging the SEM particle thicknesses. The spread value method can only be used to determine the median thickness, but not the distribution of the particle thicknesses.

Therefore, the average thickness of the aluminum effect pigment of the present invention was determined via SEM. Typically, at least 100 particles are analyzed to obtain a representative result. Details concerning the method are discernible from WO 2004/087816, the content of which is hereby incorporated herein by reference.

The median thickness h₅₀ of the aluminum effect pigments obtained by measurement from SEM pictures (SEM: scanning electron microscope) is preferably in a range of 15 to 150 nm. The average thickness h₅₀ is preferably in a range of 15 to 100 nm and more preferably of 20 to 80 nm.

It was found that, after an aluminum effect pigment-containing ink jet printer ink according to the present invention has been applied to a substrate, very appealing metal effects are obtainable using metal effect pigments having these very thin average thicknesses.

A further very preferable average thickness h₅₀ is in a range of 30 to below 80 nm. Such thin aluminum effect pigments obtained by grinding make it possible to obtain effects of great brilliance. Apart from high gloss and high flop, the prints have the appearance of a liquid metallic effect which is ordinarily typical of PVD pigments.

Less brilliant but still reasonable metallic effects are obtainable with an average thickness h₅₀ of 80 to 130 nm.

Below an h₅₀ of 15 nm, the pigments are too transparent and have reduced reflective properties, which make them appear very dark since absorption phenomena are increasingly likely. Above an h₅₀ of 150 nm, the optical performance of the aluminum effect pigment and of pigment material is wasted owing to the reduced specific hiding power, i.e., of the covered area of medium per unit weight of aluminum effect pigment.

The SEM thickness measurement likewise yields the thickness distribution. This is transformed into a cumulative distribution (number average) that can be used to determine the relative width of the thickness distribution Δh (“thickness span”) using formula (I).

The thickness span Δh is preferably in a range of 30 to 140%. In a further preferable embodiment, the average bandwidth of the thickness distribution Δh ranges from 30 to 100% and more preferably from 30 to 70% and even more preferably from 30 to 50%.

Great preference is given to aluminum effect pigments having an average thickness h₅₀ of 15 to 80 nm and a Δh of 30 to less than 70%.

It was found that, surprisingly, such a size distribution curve of thin aluminum effect pigments obtained by grinding, in the ink jet printer ink of the present invention, provides optical effects having a very high gloss and flop and also an appealing liquid metallic effect on application of this ink jet printer ink to a substrate.

A low Δh value (thickness span) is preferable in order to obtain the desired high-value optical effects. Pigments having a Δh of above 140% do not become efficiently layered in ink jet printer ink. Furthermore, owing to the short time for orientation between the application of the ink jet printer ink and the curing thereof, optimal orientation is only achievable for pigments having a Δh of less than 140% and more preferably of less than 100%.

The ink jet printer ink according to the invention preferably comprises very thin aluminum effect pigments having a rather small width (span) for the particle size distribution curve in order to enable uniform orientation of essentially all aluminum effect pigments within the short time interval available during solvent evaporation after ink jet printer ink application.

The aluminum effect pigments of the present invention preferably have a thickness distribution curve having an h₉₀ value of below 110 nm and more preferably of below 75 nm. The h₉₅ value of the thickness distribution is preferably below 150 nm and more preferably below 120 nm. In addition, the h₉₉ value is preferably below 140 nm and more preferably below 90 nm.

A further preferable embodiment utilizes pearl luster pigments as effect pigments.

The abovementioned problems with print head dimensions and potential print head cloggages arise here in the same way when excessively large pearl luster pigments are used.

The size distribution of pearl luster pigments can be determined via laser granulometry in the same way as for aluminum effect pigments. Since, however, aluminum effect pigments yield a higher signal here, owing to their optical properties (refractive index, absorption constants), the d₉₀ value is the more suitable metric for characterizing the coarse fraction in the case of pearl luster pigments. The d₉₈ value here is very difficult to measure reproducibly. The smaller this value, the better the utility in different ink jet print heads of the pearl luster pigment-containing ink jet printer inks according to the present invention.

According to the invention, the pearl luster pigments have a size distribution with a d₉₀ value of 3.5 to 15 μm. The pearl luster pigments preferably have a size distribution with a d₉₀ value from a range of 4 to 13 μm, more preferably of 5.5 to 12 μm, even more preferably 5 to 10 μm and yet even more preferably 5.1 to 8 μm.

In a further embodiment of the invention, the pearl luster pigments have a size distribution with a d₉₅ value from a range of 5 to 20 μm, preferably 5.5 to 15 μm, more preferably of 6 to 13 μm and even more preferably 6.5 to 10 μm.

In a further embodiment of the invention, the pearl luster pigments have a size distribution with a d₅₀ value of 2 to 10 μm, preferably of 2.5 to 8 μm, more preferably of 3 to 7.5 μm and even more preferably 3.5 to 6 μm.

In a preferable embodiment, the substrate of the pearl luster pigments has a median height (layer thickness) hₛ from a range of 40 to 150 nm, preferably of 50 to 140 nm, more preferably of 60 to 130 nm, more preferably of 70 to 120 nm and even more preferably of 80 to 110 nm.

Below a layer thickness of 40 nm, the pigments may be mechanically too fragile. Furthermore, the times needed to coat with metal or high-refractive metal oxide are too long, owing to the extremely high specific surface area, to be economically acceptable. Specific surface area is surface area per unit weight. Since the layer thickness of substrates of pearl luster pigments according to the present invention is extremely small, these substrates have a very large surface area, per unit weight, compared with conventional substrates.

Standard deviation of the median height hₛ is preferably in a range of 25 to 80%, more preferably of 28 to 60% and even more preferably of 30 to 50%.

Pearl luster pigment substrate particle thickness and particle size are substantially dependent on each other as a consequence of the production process. Large particle sizes occasion correspondingly large particle thicknesses, and vice versa. The printability of ink jet printer inks according to the invention is decisively affected by pearl luster pigment particle size. Excessively coarse and hence correspondingly thick pearl luster pigments are less suitable for commercially available ink jet print heads. Above 150 nm for a median height hₛ of the pearl luster pigment substrate, the printing inks, preferably ink jet inks, are not adequately printable, if at all, in commercially available ink jet print heads.

The extremely fine pearl luster pigments in the ink jet printer inks according to the invention are consequently based on a substantially transparent substrate having a low d₉₀ value and a low median layer thickness hₛ. This ensures printability in commercially available ink jet print heads and also, surprisingly, a very good mechanical stability. At the same time, the pearl luster pigments have strong interference colors and thus are useful for strong-colored high-quality prints with pearl luster effect.

It has been determined that pearl luster pigments with hereinbelow recited combinations of particle size (diameter) d₉₀/d₉₅ and layer thickness (median height) hₛ are particularly suitable. These combinations hereinbelow provide very small and fine pearl luster pigments having at the same time surprisingly high mechanical stability when ink jet printer inks according to the invention are printed in commercially available ink jet print heads. It was further extremely surprising that these small and fine pearl luster pigments have the wet-look luster typical of pearl luster pigments irrespective of their small size.

According to the invention, the ink jet printer inks according to the invention preferably contain pearl luster pigments whose d₉₀ value for the cumulative frequency distribution of the volume-averaged size distribution function is in a range from 3.5 to 15 μm and preferably in a range from 4 to 13 μm, and whose median height hₛ is in a range from 40 to 150 nm and preferably in a range from 50 to 140 nm.

In a further preferable embodiment, the ink jet printer inks of the present invention contain pearl luster pigments whose d₉₀ value for the cumulative frequency distribution of the volume-averaged size distribution function is in a range from 4.5 to 12 μm and preferably in a range from 5 to 10 μm and whose median height h₅ is in a range from 60 to 130 nm and preferably in a range from 70 to 120 nm.

In a particularly preferable embodiment, the ink jet printer inks of the present invention contain pearl luster pigments whose d₉₀ value for the cumulative frequency distribution of the volume-averaged size distribution function is in a range from 5.1 to 8 μm and whose median height hₛ is in a range from 80 to 110 nm.

In a further embodiment according to the invention, the ink jet printer inks of the present invention contain pearl luster pigments whose d₉₅ value for the cumulative frequency distribution of the volume-averaged size distribution function is in a range from 5 to 20 μm and preferably in a range from 5.5 to 15 μm and whose median height hₛ is in a range from 40 to 150 nm and preferably in a range from 50 to 140 nm.

In a further embodiment, the ink jet printer inks of the present invention contain pearl luster pigments whose d₉₅ value for the cumulative frequency distribution of the volume-averaged size distribution function is in a range from 6 to 13 μm and preferably in a range from 6.5 to 10 μm and whose median height hₛ is in a range from 60 to 130 nm and preferably in a range from 70 to 120 nm.

In a further embodiment, the ink jet printer inks of the present invention contain pearl luster pigments whose d₉₀ value for the cumulative frequency distribution of the volume-averaged size distribution function is in a range from 3.5 to 15 μm and preferably in a range from 4 to 13 μm and whose d₉₅ value for the cumulative frequency distribution of the volume-averaged size distribution function is in a range from 5 to 20 μm and preferably in a range from 5.5 to 15 μm.

In a further embodiment, the ink jet printer inks of the present invention contain pearl luster pigments whose d₉₀ value for the cumulative frequency distribution of the volume-averaged size distribution function is in a range from 4.5 to 12 μm and preferably in a range from 5 to 10 μm and whose d₉₅ value for the cumulative frequency distribution of the volume-averaged size distribution function is in a range from 6 to 13 μm and preferably in a range from 6.5 to 10 μm.

In a preferable version of the invention, the pearl luster pigments in the ink jet ink include a metal oxide layer of TiO₂ and a substrate of mica. The mica may be synthetic mica or natural mica.

The viscosity of ink jet printer ink according to the invention is in a range from 1 to 50 mPa·s. This viscosity is measured with an R/S rheometer from Brookfield having a double slot cylinder measuring system to DIN 54453 with a stipulated 150 rpm at 25° C. The viscosity of the ink jet printer ink is preferably in a range from 3 to 30 mPa·s and more preferably in a range from 4 to 20 mPa·s.

In a further preferable refinement of the invention, the ink jet printer ink according to the invention has a surface tension of 18 to 50 mN/m and more preferably of 20 to 45 mN/m, measured at a temperature of 25° C. using du Nouy's ring method.

In a further preferable refinement of the invention, the ink jet printer ink according to the invention has a conductivity of 0 to 5 mS/cm and preferably of 0.2 to 4 mS/cm, measured at a temperature of 25° C. to DIN 53779 or in a corresponding manner.

The solvent-based ink jet printer inks of the present invention preferably have a viscosity of 4 to 20 mPa·s, measured with an R/S rheometer from Brookfield having a double slot cylinder measuring system to DIN 54453 with a stipulated 150 rpm at 25° C., a surface tension of 20 to 45 mN/m, measured at a temperature of 25° C. with du Nouy's ring method, and preferably a conductivity of 0 to 5 mS/cm, measured at a temperature of 25° C. to DIN 53779 or in a corresponding manner.

In one preferable embodiment, the effect pigments, aluminum effect pigments and/or pearl luster effect pigments are present in a concentration of 0.2 to 7 wt %, more preferably 0.3-6 wt %, more preferably 0.4 to 5 wt % and even more preferably 0.5 to 3 wt %, all based on the total weight of the ink jet printer ink.

Below 0.2 wt %, effect development and here particularly the high gloss are only partially developed. The print cannot have any uninterrupted coverage with the effect pigments and therefore there can be no adequate development of the desired gloss associated therewith. Above 7 wt %, the printing inks become too expensive, since effect pigments naturally account for the highest raw material cost fraction of ink jet printer ink.

The high weight ratio of the effect pigment to binder is a feature of the ink jet printer inks according to the invention which is essential to the invention. This ratio is in the range from 2 to 15, preferably in the range from 2.5 to 10 and more preferably in the range from 2.8 to 6.25.

The quantitative ratios disclosed in the prior art are always significantly lower, as is apparent in particular from the exemplary embodiments disclosed therein. Conventionally colored ink jet printer inks customarily also have a significantly lower weight ratio of approximately 1:1. Here, relatively high binder contents of about 4-6 wt % are used in the printing ink, since the rub and wipe resistance desired for the print is not obtainable otherwise.

Below a weight ratio of 2 for effect pigment to binder there is a significant decrease in the gloss of prints, especially when printing on a non-porous substrate. Above a ratio of 15, finally, the rub and wipe resistance of the print is no longer acceptable, since there is too little binder in the print here.

The surprising finding of a high weight ratio of effect pigments to binders in the ink jet printer inks of the present invention is believed to be due to the specific surface area of the platelet-shaped effect pigments which is relatively low compared with conventional pigments. As a result, less binder is needed to bind the effect pigments into the print in a mechanically stable manner.

It must be borne in mind here that the printing of porous media, for example the matte papers and micropore-coated papers, films and plates customary in digital printing, will always lead to at least some of the binder diffusing into the pores of the medium together with the solvent. High-gloss prints are accordingly obtained because there is little or no binder in the print. However, the printed layer correspondingly lacks sufficient or any binder to ensure the coherency of the print. With some porous media such as micropore-coated high-gloss papers for example, the pores in the surface of the medium are so small that only solvent and binder are able to diffuse into the pores and not the larger effect pigments. The result is accordingly a substantial spatial separation of effect pigment and binder in the print and hence an unacceptable mechanical stability. In the extreme case, there is no longer any effect pigment adherence to the medium.

Surprisingly, the ink jet printer ink of the present invention provides a print on a non-porous substrate in particular where mechanical stability is substantially retained even at low binder contents. The binder content of the ink jet printer ink according to the present invention is preferably in the range from 0.1 to 1.3 wt %, more preferably in the range from 0.15 to 1.0 wt %, even more preferably in the range from 0.2 to 0.8 wt % and yet even more preferably in the range from 0.25 to 0.6 wt %, based on the total weight of the ink jet printer ink. The recited binder contents are each based on the binder's solids content.

Solvent-containing ink jet printer inks typically have viscosities in the range from 1 to 50 mPas. The requisite viscosity of conventional ink jet printer inks is typically controlled via the binder content. Surprisingly, the ink jet printer inks of the present invention, which contain effect pigments, are found to need very low levels of binder to achieve the requisite viscosities.

The binders used are preferably binders that are not very soluble in the particular solvent mixture used.

In preferable embodiments, (C₁-C₃ alkyl)-cellulose, cellulose acetate butyrate (CAB), nitrocellulose, vinyl chloride copolymers, acrylates, ketonic resins, epoxy resins, phenolic resins, silicone resins or mixtures thereof are used in the ink jet printer inks of the present invention as a binder. It is particularly preferable to use (C₁-C₃ alkyl)-cellulose, cellulose acetate butyrates (CAB), nitrocellulose or mixtures thereof in the ink jet printer inks of the present invention as a binder. It is very particularly preferable to use C₁-C₃ alkylcellulose as a binder, where alkyl is methyl, ethyl or propyl.

In a very particularly preferable embodiment, the ink jet printer ink of the present invention comprises ethylcellulose as a binder. This is surprising particularly because ethylcellulose is a very uncommon binder in the ink jet printing sector. Ethylcellulose generally gives the best results for gloss development of effect pigments.

When ethylcellulose is used as binder, even extremely porous medium materials such as micropore materials can be successfully printed with effect pigments in that prints are obtained with good mechanical stability. The medium in question is a paper or a film or a plate coated with a porous layer of SiO₂ and Al₂O₃. This coating has pores with an extremely small diameter. This porous structure imbibes the solvent of the ink jet printer ink immediately after printing, owing to the strong capillary forces.

The binder which in the prior art has readily dissolved in the solvent is naturally likewise absorbed and so the effect pigment no longer has any mechanical stability in the print.

Ethylcellulose possibly has enhanced affinity for effect pigments, especially aluminum effect pigments, and therefore is not subject to this mechanism.

In more preferable embodiments, the ethylcellulose used as binder has an average molar mass M_{w} (mass average) of 50 000 to 250 000 g/mol and preferably from 80 000 to 150 000 g/mol. Molar mass is preferably determined via GPC to DIN 55672 Part 1 using THF as solvent, polystyrene standards and three columns (Waters GmbH) having a length of 30 cm each and an internal diameter of 7.8 mm each and the pore sizes HR5, HR4 and HR2.

These rather low to average molar masses for ethylcellulose lead to better solubility of the binder in the solvent used.

Preferable embodiments of ink jet printer ink according to the present invention with a viscosity of 1 to 50 mPa·s and preferably of 4 to 20 mPa·s comprise the following components A and/or B:

Component A:

a) aluminum effect pigments having a median thickness of 15 to 50 nm and a d₉₈ of below 12 μm

b) a binder from the group ethylcellulose, CAB or nitrocellulose; wherein the weight ratio of aluminum effect pigment to binder is in the range from 2.5 to 6.25.

Particularly preferable embodiments of ink jet printer ink A contain the binder from the group ethylcellulose, CAB or nitrocellulose in amounts of 0.2 to 0.8 wt %.

Component B:

a) aluminum effect pigments having a median thickness of 15 to 50 nm and a d₉₈ of 2 to 12 μm and preferably of 2.5 to below 8 μm

b) ethylcellulose as binder; wherein the weight ratio of aluminum effect pigment to binder is preferably in the range from 2.5 to 6.25 and the binder is preferably present in amounts of 0.2 to 1.0 wt %, based on the total weight of the ink jet printer ink.

Particularly preferable embodiments of ink jet printer ink B contain the binder ethylcellulose with an average molar mass M_{w} of 50 000 to 250 000 g/mol.

A further aspect of the invention concerns the use of ink jet printer inks of the present invention for printing especially non-porous substrates.

Preferable non-porous substrates here are uncoated or non-porous coated films and mesh vinyl banners, glass, ceramic, painted plates, metal plates, sheet metals, treated leather, coated canvasses for painting and also gloss-coated papers.

Non-porous substrates are notable in that, after the printing operation, the solvent evaporates or at best swells or incipiently dissolves the medium. As a result, drying times are generally much longer than in the case of porous substrates, which are able to imbibe the solvent to a large proportion or completely.

Examples of uncoated films are polypropylene films, polyethylene films, vinyl films and polyester films including banner materials. Examples of painted plates are Dibond®, or foamboard products. Gravure and offset papers are typically used as gloss-coated papers. Unlike the typical ink jet papers, they are only somewhat absorbent but not porous.

The solvent-based ink jet printer ink preferably comprises a solvent content between 50 and 99 wt %, preferably between 75 and 98.5 wt % and more preferably between 85 and 98.0 wt %, based on the total weight of the ink jet printer ink.

The evaporation number of the solvent is preferably in a range between 10 and 300, more preferably between 20 and 250 and even more preferably between 80 and 200.

The evaporation number is defined by DIN 53170 relative to ether at 20° C.

Any solvent suitable for ink jet printing can be used as solvent or solvent mixture. Preferred solvents are alcohols, esters, ethers, thioethers, glycol ethers, glycol ether acetates, amines, amides, ketones and/or hydrocarbons or mixtures thereof.

Examples of alcohols are alkyl alcohols such as for example methanol, ethanol, propanol, isopropanol, butanol, pentanol, hexanol, fluorinated alcohols or mixtures thereof.

Examples of ketones useful as solvents are acetone, methyl ethyl ketone, cyclohexanone, diisobutyl ketone, methyl propyl ketone, diacetone alcohol or mixtures thereof.

Examples of esters are methyl acetate, ethyl acetate, 1-methoxy-2-propyl acetate, propyl acetate, ethoxy-propyl acetate, butyl acetate, methyl propionate or ethyl propionate, glycol ether acetates, butylglycol acetate, propylene glycol diacetate, ethyl lactate or mixtures thereof.

Examples of ethers useful as solvents are diethyl ether, dipropyl ether, tetrahydrofuran, dioxane, ethylene glycol ether, especially ethylene glycol ethyl ether or ethylene glycol methyl ether, methoxypropanol, dipropylene glycol dimethyl ether, 3-methoxy-3-methyl-1-butanol, propylene glycol butyl ether or mixtures thereof.

Examples of amides useful as solvents are N-methyl-pyrrolidone and 2-pyrrolidone.

The hydrocarbons may be selected from the group consisting of terpenes, such as pinene, limonene, terpinolene, aliphatic hydrocarbons such as heptane, white spirit, Stoddard Solvent and/or aromatic hydrocarbons such as toluene, xylene, Solvent Naphtha or mixtures thereof.

Suitable solvents are more particularly selected from the group consisting of alcohols, glycol ethers, esters, ketones or mixtures thereof. Solvent for the purposes of the present invention is to be understood as meaning a single solvent or a solvent mixture.

Particularly preferable solvents are isopropanol, ethanol, butanol, diisobutyl ketone, butylglycol, butylglycol acetate, propylene glycol diacetate, dipropylene glycol dimethyl ether, ethyl lactate or ethoxypropyl acetate or 3-methoxy-3-methyl-1-butanol.

Preferably, the organic solvent or solvent mixture contains no water. Small amounts of water present as industrial impurity for example are only insignificantly disruptive, if at all. The water content is preferably less than 20 wt %, more preferably less than 10 wt % and even more preferably less than 5 wt %. It is extremely preferable for the water content to be less than 2 wt %, these particulars all being based on the total weight of solvent/solvent mixture.

In a further embodiment, the solvent/solvent mixture in ink jet inks used in the drop-on-demand (DOD) technology preferably have a flashpoint of at least 61° C. or higher. This ensures that the printing presses should not have to be located in an explosion-protected area or be given an explosion-protected design. Furthermore, storing and transporting such an ink jet printer ink is safer.

In a further embodiment of the invention, the ink jet printer ink has a surface tension of 18 to 50 mN/m, preferably of 20 to 40 mN/m and more preferably of 22 to 35 mN/m.

When the surface tension is below 18 mN/m, the ink jet printer ink can flow over the surface of the print head, leading to difficulties with the ejection of ink droplets. In addition, the ink can spread on the substrate to be printed, resulting in a poor printed image. When the surface tension is above 50 mN/m, the substrate to be printed cannot be wetted and the ink does not spread on the substrate to be printed.

Preferably, the ink jet printer ink additionally comprises additives, for example dispersing agents, antisettling agents, humidifying agents, wetting agents including anticratering or flow control additives, biocides, pH regulators, plasticizers, UV stabilizers or mixtures thereof.

Dispersing agents help to achieve a homogeneous dispersion of all solid constituents in the ink jet ink. More particularly, any possible agglomeration of pearl luster pigments is avoided.

The ink jet printer ink composition according to the invention may contain a dispersing agent. Useful dispersing agents include all commonly used dispersing agents which are used in a customary printing ink, in particular ink composition, such as gravure printing ink, offset ink, intaglio ink or screen printing ink. Commercially available products can be used as dispersing agents. Examples thereof include Solsperse 20000, 24000, 30000, 32000, 32500, 33500, 34000 and 35200 (from Avecia K.K.) or Disperbyk-102, 106, 111, 161, 162, 163, 164, 166, 180, 190, 191 and 192 (from BYK-Chemie GmbH).

Substances are said to prevent the settling of platelet-shaped effect pigments in the ink jet ink. Examples thereof are Byk-405 in conjunction with pyrogenous silica, modified ureas such as Byk-410 or Byk-411 or waxes such as Byk Ceramat 237, Ceramat 250, Cerafak 103, Cerafak 106 or Ceratix 8461.

In a further preferable embodiment, the ink jet printer ink of the present invention contains wetting agents.

Wetting agents serve to improve the wetting of the substrate to be printed. Wetting agents are also important for the functioning of the print head, since internal structures, for example channels, filters, nozzle antechambers, etc. are also wetted. Examples of suitable wetting agents include fatty acid alkyl ethers, acetylene derivatives, fluorinated esters, fluorinated polymers or silicone compounds.

Biocides can be incorporated in the ink jet printer ink according to the invention to prevent any growth of microorganisms. Useful examples include polyhexamethylenebiguanides, isothiazolones, isothia-zolinones, for example 5-chloro-2-methyl-4-iso-thiazolin-3-one (CIT), 2-methyl-4-isothiazolin-3-one (MIT), etc. or mixtures thereof.

Ammonia or amines such as triethanolamine or dimethyl-ethanolamine can be added to the ink jet printer ink to adjust the pH.

Useful plasticizers for addition to the ink jet printer ink include for example citric esters, adipic esters, phosphoric esters and higher alcohols.

2,6-Di-tert-butylphenol is an example of a UV stabilizer that can be added to the ink jet printer ink of the present invention.

The ink jet printer ink of the present invention can be applied to different substrates to be printed. The substrate is preferably selected from the group consisting of coated or uncoated paper or paperboard, polymeric substrates (plastics), metals, ceramic, glass, textiles, leather or of combinations thereof. The most preferred substrates consist of polymeric substrates (plastics), such as polymeric films/sheets (e.g., PVC or PE films/sheets).

The ink jet printer ink according to the present invention can be used with any possible ink jet technology with the exception of UV systems. The ink jet ink of the present invention can be used in various ink jet printing systems. The ink jet printing systems may on the one hand be systems wherein droplets are electrostatically charged and deflected (continuous ink jet processes). It is also possible to use ink jet printing systems in which droplets are formed by pressure waves generated by piezoelectric elements (drop-on-demand processes).

The ink jet printer ink of the present invention is preferably used with impulse or piezo drop-on-demand ink jet technology—DOD.

A resolution of at least 300 dpi is expected as standard to ensure good quality of printing.

The problem addressed by the present invention is further also solved by an article printed with the ink jet printer ink of the present invention. The article comprises more particularly the abovementioned substrates, such as films, papers, paperboards, boards, glass, ceramic, plates, metal sheets, leather, etc.

### EXAMPLES

The examples which follow further elucidate the invention without, however, restricting it.

A Ink Jet Printer Ink Recipes

Three different ink recipes were developed. Depending on the pigment/binder ratio used, they are inventive examples or comparative examples.

Ink jet printer ink recipe 1:

| | |
|---|---|
| propylene glycol diacetate: | 37 wt % |
| butylglycol acetate: | 20 wt % |
| dipropylene glycol dimethyl ether: | 12.7 wt % |
| ethoxypropyl acetate: | 20 wt % |
| Fluorad-FC4430: | 0.3 wt % |
| N200 ethylcellulose:* | 0.4 wt % |
| aluminum effect pigment dispersion:** | 12 wt % |
| (10 wt % aluminum content, based on total weight | |
| of aluminum effect pigment dispersion, Eckart) | |

*N200 ethylcellulose had a molecular weight M_{w} of 116 000 g/mol. Measured via GPC to DIN 55672 Part 1 using THF as solvent, polystyrene standards and three columns (Waters GmbH) having a length of 30 cm each and an internal diameter of 7.8 mm each and the pore sizes HR5, HR4 and HR2.
**A PVD aluminum effect pigment brought to the desired particle size (D₅₀ 1.8 μm) as described in example 2 of WO 2009/083176 Al by grinding.

Ink jet printer ink recipe 2:

| | |
|---|---|
| solvent mixture: | 87.3 wt % to |
| | 65.7 wt % |
| consisting of | |
| propylene glycol diacetate | 34.4 wt % |
| 1-butoxy-2-propanol | 40.4 wt % |
| dipropylene glycol dimethyl ether | 13.7 wt % |
| ethoxypropyl acetate | 11.5 wt % |
| Fluorad-FC4430: | 0.3 wt % |
| various binders: (see table 2) | 0.4 wt %-4.0 wt % |
| aluminum effect pigment dispersion:* | 12 wt %-30 wt % |
| (10 wt % aluminum content, based on total weight | |
| of aluminum effect dispersion, Eckart) | |

*As for ink recipe 1.

When the concentration of the aluminum effect pigment dispersion is more than 12% and/or the binder concentration is more than 0.4%, the concentration of the solvent mixture is adapted correspondingly, taking care not to alter its composition.

Ink jet printer ink recipe 3:

| | |
|---|---|
| solvent mixture: | 68.75 wt % |
| consisting of | |
| dipropylene glycol dimethyl ether | 52.4 wt % |
| 1-butoxy-2-propanol | 47.6 wt % |
| Byk 340: | 0.25 wt % |
| various binders: (see table 3) | 1 wt % to 8.2 wt % |
| aluminum effect pigment dispersion:* | 30 wt % |
| (10 wt % aluminum content, based on total weight | |
| of aluminum effect pigment dispersion, Eckart) | |

*As for ink recipe 1.

When the concentration of the binders is more than 1%, the concentration of the solvent is adapted correspondingly, care being taken, however, to ensure that the composition of the solvent mixture is not altered.

All particulars are wt %, each based on total weight of the ink jet printer ink unless otherwise stated. Each ink jet printer ink was produced in an amount of 100 g.

B Use Examples:

Use Examples 1a)-c):

Ink jet printer inks 1 to 3 from section A were printed up in a digital large-format printer from Mimaki (of the JV3-160S type). The 100% area print test customary with this type of printer was used to produce 50 x 400 mm strips on various common substrates. The gloss values of the prints were measured using a Micro-Tri-Gloss gloss meter from Byk Gardner at a measurement angle of 60°. Wipe resistance was tested manually and assessed on a 3-step scale.

The following settings were chosen in the printer's test menu:

fraction of maximum ink application: 100%

resolution: 720 dpi

forward feed steps: 16 Pass

directional print head movement: Bi

forward feed speed: High speed=off, i.e., normal speed

The dryer device temperature setting was 50° C. in the intake region and 45° C. in the printing region.

TABLE 1
Ink recipe 1 binders and gloss values

| | | 60° gloss | Wipe |
|---|---|---|---|
| Samples | Substrate | value | resistance |
| Example 1a | Igepa Master Screen | 404 | acceptable |
| | Self Adhesive Vinyl | | |
| Example 1b | Melinex 400 | 506 | Acceptable |
| | Polyester Film | | |
| Example 1c | Sihl Maranello | 561 | Good |
| | Photo Paper | | |

All the examples exhibit high gloss values and acceptable to good wipe resistance. The Sihl Maranello Photo Paper is a porous substrate, while the other two substrates have no porosity. Therefore, a higher actual effect pigment/binder ratio will be present in the print in the case of example 1c than with the other examples. The higher gloss of example 1c is presumably attributable to this.

Surprisingly, however, the prints of examples 1a and 1b also have a high gloss and an acceptable wipe resistance.

Use Examples 2a) and 2b):

Various comparative examples and inventive examples were produced in accordance with ink jet printer ink recipe 2 by choosing various binders and different pigment/binder concentrations (see table 2). These examples were printed up in a digital large-format printer from Mimaki (of the JV3-160S) type.

Mixed poster motifs featuring different fractions of metallic colors were printed using commercially customary settings.

In fact, two typical printer settings were chosen:

| | a) | | b) | |
|---|---|---|---|---|
| Resolution: | 720 | dpi | 360 × 540 | dpi |
| Forward feed steps: | 8 | Pass | 6 | Pass |

| | | |
|---|---|---|
| Forward feed speed: | High Speed | High Speed |
| Directional print head movement: | Bi | Bi |

The printer was operated for several weeks at several hours a day without operational upsets.

This means that there were no print head cloggages.

Various comparative examples and inventive examples were further produced in accordance with ink jet printer ink recipe 2 by choosing various binders and different pigment/binder concentrations, and printed up under the conditions of use examples 1 onto Igepa Masterscreen permanent (self-adhesive vinyl film) as substrate. This substrate is not porous.

TABLE 2
Ink recipe 2 constituents, gloss values and rub test values

| | Al | | | | | | |
|---|---|---|---|---|---|---|---|
| | pigment | | Binder | Binder | | | Rub test |
| | content | Type of | tradename/ | content | Al/ | 60° | result |
| Sample | in wt % | binder | producer | in wt % | binder | gloss | (PVC) |
| Comp. | 3.0 | PVC/PVAc | Vinylite VYHH | 2.7 | 1.1 | 140 | acceptable |
| Example 2a | | Copo | (Dow Chemical) | | | | |
| Comp. | 1.2 | PVB | Pioloform BN18 | 4.0 | 0.3 | 80 | acceptable |
| Example 2b | | | (Wacker Chemie) | | | | |
| Comp. | 1.2 | Acrylate | Joncryl 661 | 4.0 | 0.3 | 70 | acceptable |
| Example 2c | | | (Johnson | | | | |
| | | | Polymer) | | | | |
| Comp. | 1.2 | PVC/PVAc | Vinylite VYHH | 2.7 | 0.4 | 95 | good |
| Example 2d | | Copo | (Dow Chemical) | | | | |
| Comp. | 1.2 | PVC/PVAc | Vinylite VYHH | 2.0 | 0.6 | 110 | good |
| Example 2e | | Copo | (Dow Chemical) | | | | |
| Inv. | 1.2 | CAB | CAB 551 | 0.5 | 2.4 | 230 | poor |
| Example 2a | | | (Eastman) | | | | |
| Comp. | 1.2 | PVC/PVAc | Vinylite VYHH | 2.0 | 0.6 | 130 | good |
| Example 2g | | Copo | (Dow Chemical) | | | | |
| Comp. | 1.2 | CAB | CAB 551 | 1.0 | 1.2 | 216 | poor |
| Example 2h | | | (Eastman) | | | | |
| Inv. | 1.2 | Ethylcellulose | Ethocel 200 | 0.4 | 3.0 | 404 | acceptable |
| Example 2b | | N200 | (Dow Chemical) | | | | |

The comparative examples with low effect pigment/binder ratio consistently have lower gloss values than inventive examples 2a and 2b. In fact, the gloss value appears to increase approximately linearly with the effect pigment/binder ratio. The mechanical properties of example 2b were acceptable, surprisingly, despite the low binder fraction.

Use Examples 3:

Various comparative examples and inventive examples were produced in accordance with ink jet printer ink recipe 3 by choosing various binders and different pigment/binder concentrations (see table 3). These ink jet printer inks were each printed up using a stationary print head.

The inks were initially charged to a vessel and pumped from there into the ink supply system of an ink jet print head. Print head temperature was set to 30° C. to achieve the requisite viscosity of 8-20 mPa*s.
Print head: Dimatix Spectra Nova PH 256/80AAA
Ink supply system: Spectra Apollo II Print head support kit
Conditions: Head temperature 40° C.
   Droplet generation frequency 5 kHz
   Resolution: 300 dpi
   Operating voltage 100V
   Wave form 6/2/2 μs
Test form: 100% Jet pattern, all nozzles,
   15 minutes continuous operation

No nozzle outages were found in any of the cases.

The ink jet printer inks were further printed onto the Igepa Master Screen self-adhesive vinyl as non-porous substrate.

TABLE 3
Ink recipe 3 constituents and Dimatix trial gloss values

| | Al | | | | | | |
|---|---|---|---|---|---|---|---|
| | pigment | | Binder | Binder | | | |
| | content | | content | tradename/ | Al/ | 60° | Rub |
| Sample | in wt % | Binder | in wt % | producer | binder | gloss | (PVC) |
| Comp. | 3.0 | PVB | 8.2 | Pioloform BN18 | 0.4 | 77 | good |
| Example 3a | | | | (Wacker Chemie) | | | |
| Comp. | 3.0 | PVC/PVAc | 4.7 | Vinylite VYHH | 0.6 | 110 | good |
| Example 3b | | Copo | | (Dow Chemical) | | | |
| Inv. | 3.0 | Ethylcellulose | 1.0 | Ethocel 200 | 3.0 | 320 | acceptable |
| Example 3 | | N200 | | (Dow Chemical) | | | |

The gloss value of the printout onto Igepa Master Screen self-adhesive vinyl was 320. The generally lower gloss values as compared with the Mimaki system are attributable to the significantly lower resolution and the higher drop volume (Dimatix: 80 pl, Mimaki: 4 pl) of the Dimatix print head. Many lower gloss values are shown by comparative examples 3a and 3b, which utilized very much lower pigment/binder ratios.

What is claimed is:

1. An ink jet printer ink comprising effect pigments and organic solvents or a solvent mixture, wherein an amount of water in the ink is less than 10 wt. % based on the total weight of the solvent or solvent mixture and wherein the effect pigments comprise at least one selected from the group consisting of
a) aluminum effect pigments having an average thickness in a range of from 10 to 100 nm and having a d₉₈ value of less than 15 μm for a cumulative frequency distribution of a volume-averaged size distribution function,
b) pearl luster pigments having a d₉₀ value in a range of from 3.5 to 15 μm for a cumulative frequency distribution of a volume-averaged size distribution function, and
c) combinations thereof,
and in that the ink jet printer ink further comprises
(i) ethylcellulose as a binder with an average molar mass Mw (mass average) of 80,000 to 150,000 g/mol, wherein the content of the ethyl cellulose binder is in the range from 0.15 to 0.8 wt. %, based on the total weight of the ink jet printer ink,
(ii) the ink jet printer ink has a viscosity in a range of from 1 to 50 mPa*s, measured with an R/S rheometer from Brookfield having a double slot cylinder measuring system in accordance with DIN 54453 with a stipulated 150 rpm at 25° C. and
(iii) an effect pigment to binder weight ratio in a range of from 2 to 6.25 and wherein said ink jet printer ink has a conductivity in range of from 0 to 5 mS/cm.

2. The ink jet printer ink as claimed in claim 1, wherein the at least one of the aluminum effect pigments or the pearl luster pigments are present in a concentration of 0.2 to 7 wt. %, based on the total weight of the ink jet printer ink.

3. The ink jet printer ink as claimed in claim 1, wherein the binder is present in said ink in an amount of from 0.2 to 0.8 wt. %, based on the total weight of the ink jet printer ink.

4. The ink jet printer ink as claimed in claim 1, wherein the solvent or solvent mixture has an evaporation number in a range of from 10 to 300.

5. The ink jet printer ink as claimed in claim 1, wherein the aluminum effect pigments have a d₉₈ value of below 12 μm.

6. The ink jet printer ink as claimed in claim 1, wherein the aluminum effect pigments are obtained by grinding.

7. The ink jet printer ink as claimed in claim 1, wherein the aluminum effect pigments are physical vapor deposition aluminum effect pigments.

8. The ink jet printer ink as claimed in claim 1, wherein the aluminum effect pigments have a median thickness h₅₀ in a range of from 15 to 50 nm.

9. The ink jet printer ink as claimed in claim 1, wherein the aluminum effect pigments have a thickness distribution Δh of 20 to 60%, calculated according to formula (I)
Δh=100(h₉₀−h₁₀)/h₅₀ (I)
wherein the h₁₀-value indicates the maximum pigment thickness of 10% of particles, the h₅₀-value indicates the maximum pigment thickness of 50% of particles, and wherein the h₉₀-value indicates the maximum pigment thickness of 90% of particles.

10. The ink jet printer ink as claimed in claim 1, wherein the pearl luster pigments have a d₉₀ value in a range of from 4 to 13 μm for the cumulative frequency distribution of the volume-averaged size distribution function.

11. The ink jet printer ink as claimed in claim 1, wherein the ink jet printer ink has a viscosity in a range of from 3 to 30 mPa*s.

12. The ink jet printer ink as claimed in claim 1, wherein the ink jet printer ink has a surface tension in a range of from 18-50 mN/m.

13. The ink jet printer ink as claimed in claim 1, wherein the ink jet printer ink has a conductivity of from 0.2 to 5 mS/cm.

14. A method for printing a substrate, wherein the method comprises printing on said substrate with the ink jet printer ink of claim 1.

15. The method as claimed in claim 14, wherein the substrate is selected from the group consisting of paper, polymers, metals, glass, textiles, leather and wood-based materials.

16. The method as claimed in claim 14 wherein the substrate is a non-porous substrate.

17. An article printed with the ink jet printer ink as claimed in claim 1.

18. The ink jet printer ink as claimed in claim 1, wherein the ink jet printer ink has a viscosity of 4 to 20 mPa·s measured with an R/S rheometer from Brookfield having a double slot cylinder measuring system according to DIN 54453 with a stipulated 150 rpm at 25° C., a surface tension at 20 to 45 mN/m, measured at a temperature of 25° C. with du Nouy's ring method and a conductivity of 0 to 5 mS/cm, measured at a temperature of 25° C. according to DIN 53779.

19. The ink jet printer ink as claimed in claim 1, wherein the binder is present in said ink in an amount of from 0.15 to 0.6 wt. % based on the total weight of the ink jet printer ink.
